(19) United States
(12) Patent Application Publication
(10) Pub. No.: US 2019/0242626 A1
(43) Pub. Date: Aug. 8, 2019

(54) Beverage Cooling Assembly

(71) Applicant: David Mesquite, Alta Loma, CA (US)

(72) Inventor: David Mesquite, Alta Loma, CA (US)

(21) Appl. No.: 15/891,115

(22) Filed: Feb. 7, 2018

(51) Int. Cl. F25B 21/02; A47J 41/00; F25D 31/00; B65D 23/10

(52) U.S. Cl. CPC F25B 21/02; A47J 41/005; B65D 23/102; F25D 31/002; A47J 41/0027

(57) ABSTRACT

A beverage cooling assembly for cooling a beverage without ice includes a canister for containing a beverage. The canister is comprised of a thermally conductive material such that the canister is in thermal communication with the beverage. A sleeve is provided and the sleeve is positioned around the canister. The sleeve is comprised of a thermally insulating material to inhibit thermal communication between the beverage and ambient air. A cooling unit is coupled to the sleeve and the cooling unit is in thermal communication with the canister. The cooling unit uses the Peltier effect to create a heat flux between the cooling unit and the canister. In this way the cooling unit cools the beverage in the canister without ice.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to cooling devices and more particularly pertains to a new cooling device for cooling a beverage without ice.

### BRIEF SUMMARY OF THE INVENTION

An embodiment of the disclosure meets the needs presented above by generally comprising a canister for containing a beverage. The canister is comprised of a thermally conductive material such that the canister is in thermal communication with the beverage. A sleeve is provided and the sleeve is positioned around the canister. The sleeve is comprised of a thermally insulating material to inhibit thermal communication between the beverage and ambient air. A cooling unit is coupled to the sleeve and the cooling unit is in thermal communication with the canister. The cooling unit uses the Peltier effect to create a heat flux between the cooling unit and the canister. In this way the cooling unit cools the beverage in the canister without ice.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a beverage cooling assembly according to an embodiment of the disclosure.

FIG. 2 is an exploded perspective view of an embodiment of the disclosure.

FIG. 3 is a bottom view of a lid of an embodiment of the disclosure.

FIG. 4 is a right side view of an embodiment of the disclosure.

FIG. 5 is a cross sectional view taken along line 5-5 of FIG. 4 of an embodiment of the disclosure.

### DETAILED DESCRIPTION OF THE INVENTION

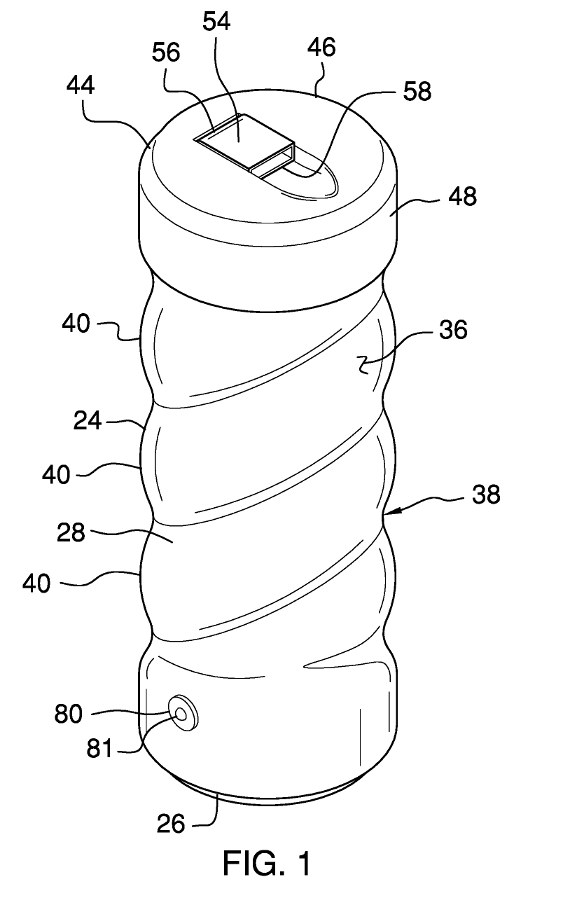

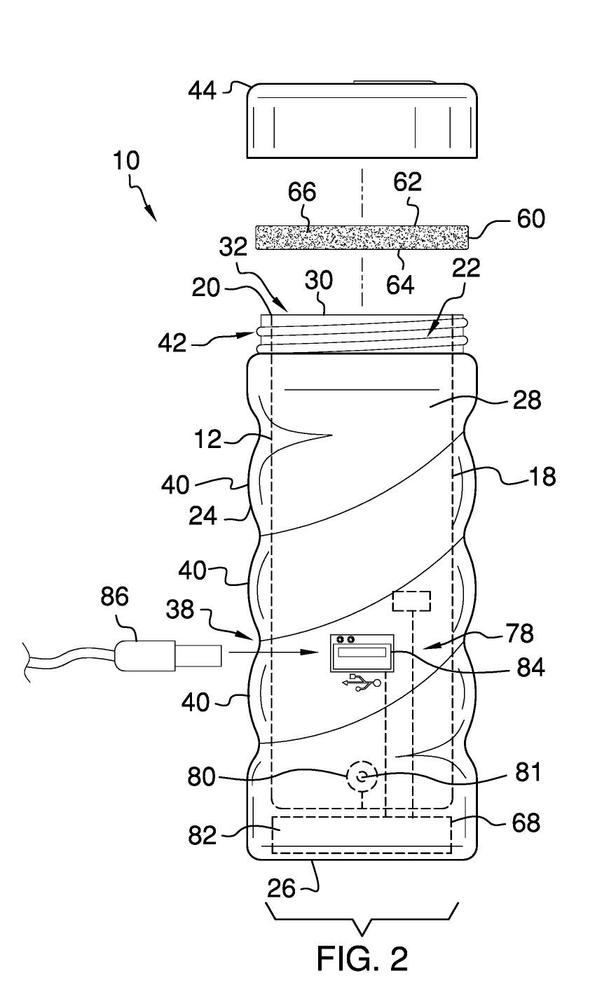

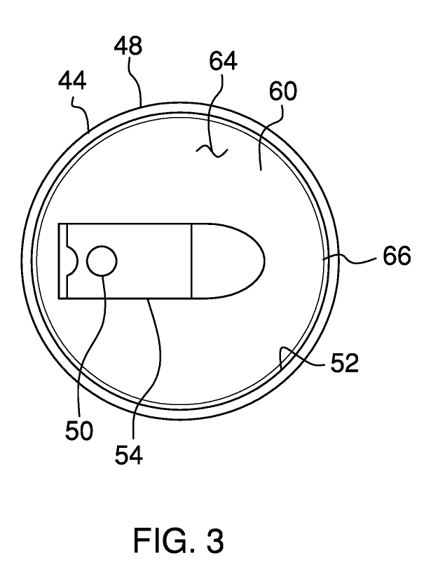

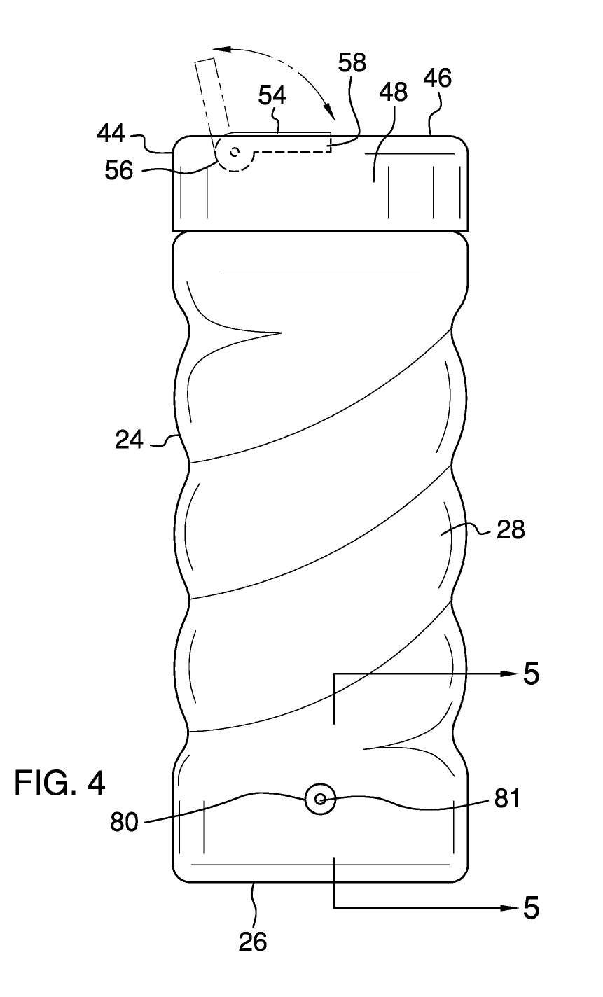

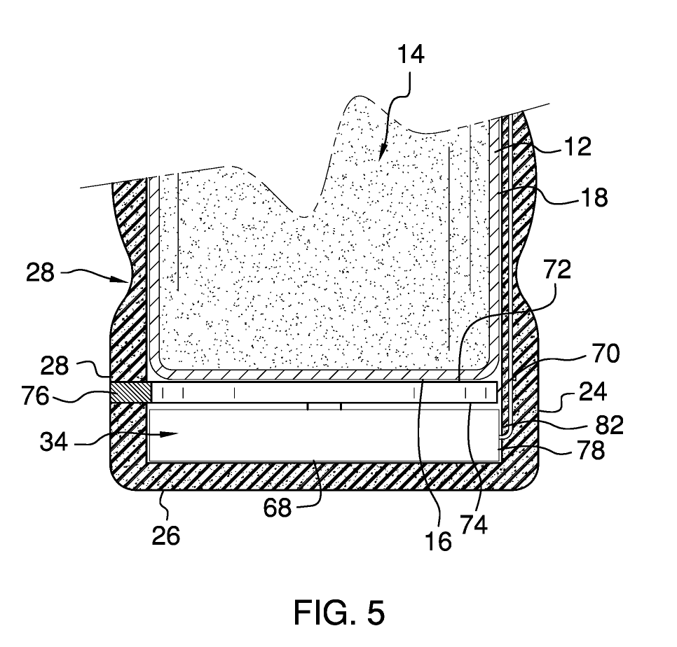

With reference now to the drawings, and in particular to FIGS. 1 through 5 thereof, a new cooling device embodying the principles and concepts of an embodiment of the disclosure and generally designated by the reference numeral 10 will be described.

As best illustrated in FIGS. 1 through 5, the beverage cooling assembly 10 generally comprises a canister 12 for containing a beverage 14. The canister 12 is comprised of a thermally conductive material such as steel or the like and the canister 12 is in thermal communication with the beverage 14. The canister 12 has a bottom wall 16 and an outer wall 18 extending upwardly therefrom. The outer wall 18 has a distal edge 20 with respect to the bottom wall 16 defining an opening 22 into the canister 12 for pouring the beverage 14 into said canister 12.

A sleeve 24 is provided and the sleeve 24 is positioned around the canister 12. The sleeve 24 is comprised of a thermally insulating material to inhibit thermal communication between the beverage 14 and ambient air. The sleeve 24 has a basal wall 26 and an outside wall 28 extending upwardly therefrom and he outside wall 28 has a distal edge 30 with respect to the basal wall 26 to define an opening 32 into the sleeve 24. The canister 12 is positioned in the sleeve 24 having the outer wall 18 of the canister 12 engaging the outside wall 28 of the sleeve 24. Moreover, the basal wall 26 is spaced from the bottom wall 16 to define a cooling space 34 between the basal wall 26 and the bottom wall 16. The distal edge 20 of the canister 12 is aligned with the distal edge 23 of the sleeve 24.

The outside wall 28 has an outer surface 36 and the outer surface 36 has a depression 38 extending inwardly therein. The depression 38 coils around the outer wall 18 and extends upwardly between the bottom wall 16 and the distal edge 20 to define a plurality of hills 40 on the outer wall 18. The hills 40 enhance gripping the canister 12 thereby inhibiting the canister 12 from being dropped. The outer wall 18 has a threaded portion 42 and the threaded portion 42 extends downwardly from the distal edge 20 of the sleeve 24.

A lid 44 is with removably coupled to the sleeve 24 and the lid 44 closes the canister 12 to inhibit the beverage 14 from escaping the canister 12. The lid 44 has a top wall 46 and perimeter wall 48 extending downwardly therefrom and the perimeter wall 48 is continuous such that the lid 44 has a circular shape. The top wall 46 has an opening 50 extending therethrough to facilitate the beverage 14 to pour outwardly therethrough for consuming the beverage 14. The perimeter wall 48 has an inside surface 52 and the inside surface 52 threadably engages the threaded portion 42 on the outer wall 18 of the sleeve 24 to retain the lid 44 on the sleeve 24.

A spout 54 is movably coupled to the lid 44 and the spout 54 is in fluid communication with an interior of the canister 12. The spout 54 is facilitates the beverage 14 to be drank from the canister 12. The spout 54 has a first end 56 and a second end 58 and each of the first end 56 and the second end 58 is open. The first end 56 is pivotally coupled to the top wall 46 of the lid 44 and the spout 54 is aligned with the opening 50 in the lid 44.

The spout 54 is positioned in a first position having the spout 54 extending upwardly from the lid 44 and having the first end 56 being in fluid communication with the opening 50 in the lid 44. In this way the spout 54 is facilitated to pass the beverage 14 therethrough for drinking. The spout 54 is positioned in a second position having the spout 54 lying flat on the lid 44 and having the first end 56 being removed from fluid communication with the opening 22. In this way the spout 54 inhibits the beverage 14 from passing therethrough.

A cooling unit 68 is provided and the cooling unit 68 is coupled to the sleeve 24. Moreover, the cooling unit 68 is in thermal communication with the canister 12. The cooling unit 68 uses the Peltier effect to create a heat flux between the cooling unit 68 and the canister 12. In this way the cooling unit 68 cools the beverage 14 in the canister 12 without ice, a compressor or an evaporator.

The cooling unit 68 comprises a Peltier cooler 70 that has a first surface 72 and a second surface 74. The Peltier cooler 70 is positioned in the cooling space 34 having the first surface 72 abutting the bottom wall 16 of the canister 12. Thus, the first surface 72 is in thermal communication with the bottom wall 16. The second surface 74 is heated when the Peltier cooler 70 is turned on such that the first surface 72 is cooled using the Peltier effect. In this way the Peltier cooler 70 cools the canister 12 and consequently cools the beverage 14 in the canister 12.

A heat sink 76 is coupled to the sleeve 24 and the heat sink 76 is in thermal communication with ambient air. The heat sink 76 is in thermal communication with the second surface 74 of the Peltier cooler 70 to exchange heat between the second surface 74 of the Peltier cooler 70 and the ambient air. The heat sink 76 may be a thermally conductive plate, a ribbed heat exchanger and any other conventional type of heat sink 76.

A power supply 78 is coupled to the sleeve 24 and the power supply 78 is electrically coupled the Peltier cooler 70. The power supply 78 comprises a switch 80 that is coupled to the outside wall 28 of the sleeve 24. The switch 80 is electrically coupled to the Peltier cooler 70 such that the switch 80 turns the Peltier cooler 70 on and off. At least one battery 82 is positioned between the Peltier cooler 70 and the basal wall 26 of the sleeve 24 and the at least one battery 82 is electrically coupled to the switch 80. The at least one battery 82 may be a rechargeable, Lithium ion battery 82 or the like.

A charge port 84 is coupled to the outside wall 28 of the sleeve 24 and the charge port 84 is electrically coupled to the at least one battery 82. The charge port 84 is selectively and electrically coupled to a power source 86 thereby facilitating the at least one battery 82 to be charged. The charge port 84 may be a usb port or the like and the power source 86 may be a usb cord that is electrically coupled to a source of electrical current.

In use, the beverage 14 is poured into the canister 12 and the lid 44 is coupled to the sleeve 24. The spout 54 is selectively urged into the first position to drink the beverage 14 from the container. The switch 80 is selectively manipulated to turn the Peltier cooler 70 on when the beverage 14 reaches an undesirably high temperature. The Peltier cooler 70 exchanges heat between the canister 12 and the heat sink 76 thereby facilitating the beverage 14 in the canister 12 to be cooled. In this way the Peltier cooler 70 facilitates the beverage 14 to be cooled and/or maintained at a cooled temperature in a remote location without the use of ice.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A beverage cooling assembly being configured to contain and cool a beverage without ice, said assembly comprising:
a canister being configured to contain a beverage, said canister being comprised of a thermally conductive material wherein said canister is configured to be in thermal communication with the beverage;
a sleeve being positioned around said canister, said sleeve being comprised of a thermally insulating material wherein said sleeve is configured to inhibit thermal communication between the beverage and ambient air; and
a cooling unit being coupled to said sleeve such that said cooling unit is in thermal communication with said canister, said cooling unit using the Peltier effect to create a heat flux between said cooling unit and said canister wherein said cooling unit is configured to cool the beverage in said canister without ice.

2. The assembly according to claim 1, wherein said canister has a bottom wall and an outer wall extending upwardly therefrom, said outer wall having a distal edge with respect to said bottom wall defining an opening into said canister wherein said opening is configured to have the beverage poured therethrough.

3. The assembly according to claim 2, wherein said sleeve has a basal wall and an outside wall extending upwardly therefrom, said outside wall having a distal edge with respect to said basal wall to define an opening into said sleeve, said canister being positioned in said sleeve having said outer wall of said canister engaging said outside wall of said sleeve and having said basal wall being spaced from said bottom wall to define a cooling space between said basal wall and said bottom wall, said distal edge of said canister being aligned with said distal edge of said sleeve.

4. The assembly according to claim 3, wherein said outside wall has an outer surface, said outer surface having a depression extending inwardly therein, said depression coiling around said outer wall and extending upwardly between said bottom wall and said distal edge to define a plurality of hills on said outer wall wherein said hills are configured to enhance gripping said canister.

5. The assembly according to claim 4, wherein said outer wall has a threaded portion, said threaded portion extending downwardly from said distal edge of said sleeve.

6. The assembly according to claim 5, further comprising a lid being removably coupled to said sleeve such that said lid closes said canister wherein said lid is configured to inhibit the beverage from escaping said canister, said lid having a top wall and perimeter wall extending downwardly therefrom, said perimeter wall being continuous such that said lid has a circular shape, said top wall having an opening extending therethrough wherein said opening is configured to facilitate the beverage to pour outwardly therethrough thereby facilitating the beverage to be consumed, said perimeter wall having an inside surface, said inside surface threadably engaging said threaded portion on said outer wall of said sleeve to retain said lid on said sleeve.

7. The assembly according to claim 6, further comprising a spout being movably coupled to said lid such that said spout is in fluid communication with an interior of said canister wherein said spout is configured to have the beverage drunk therethrough, said spout having a first end and a second end, each of said first end and said second end being open, said first end being pivotally coupled to said top wall of said lid having said spout being aligned with said opening in said lid.

8. The assembly according to claim 7, wherein said spout is positioned in a first position having said spout extending upwardly from said lid and having said first end being in fluid communication with said opening wherein said spout is configured to pass the beverage therethrough, said spout being positioned in a second position having said spout lying flat on said lid having said first end being removed from fluid communication with said opening wherein said spout is configured to inhibit the beverage from passing therethrough.

9. The assembly according to claim 3, wherein said cooling unit comprises a Peltier cooler having a first surface and a second surface, said Peltier cooler being positioned in said cooling space, said first surface of said Peltier cooler abutting said bottom wall of said canister such that said first surface is in thermal communication with said bottom wall, said second surface being heated when said Peltier cooler is turned on such that said first surface is cooled using the Peltier effect.

10. The assembly according to claim 9, further comprising a heat sink being coupled to said sleeve wherein said heat sink is configured to be in thermal communication with ambient air, said heat sink being in thermal communication with said second surface of said Peltier cooler wherein said heat sink is configured to exchange heat between said second surface of said Peltier cooler and the ambient air.

11. The assembly according to claim 9, further comprising a power supply being coupled to said sleeve, said power supply being electrically coupled said Peltier cooler.

12. The assembly according to claim 11, wherein said power supply comprises a switch being coupled to said outside wall of said sleeve wherein said switch is configured to be manipulated said switch being electrically coupled to said Peltier cooler such that said switch turn said Peltier cooler on and off.

13. The assembly according to claim 12, further comprising at least one battery being positioned between said Peltier cooler and said basal wall of said sleeve, said at least one battery being electrically coupled to said switch.

14. The assembly according to claim 13, further comprising a charge port being coupled to said outside wall of said sleeve, said charge port being electrically coupled to said at least one battery, said charge port being configured to be electrically coupled to a power source thereby facilitating said at least one battery to be charged.

15. A beverage cooling assembly being configured to contain and cool a beverage without ice, said assembly comprising:
a canister being configured to contain a beverage, said canister being comprised of a thermally conductive material wherein said canister is configured to be in thermal communication with the beverage, said canister having a bottom wall and an outer wall extending upwardly therefrom, said outer wall having a distal edge with respect to said bottom wall defining an opening into said canister wherein said opening is configured to have the beverage poured therethrough;
a sleeve being positioned around said canister, said sleeve being comprised of a thermally insulating material wherein said sleeve is configured to inhibit thermal communication between the beverage and ambient air, said sleeve having a basal wall and an outside wall extending upwardly therefrom, said outside wall having a distal edge with respect to said basal wall to define an opening into said sleeve, said canister being positioned in said sleeve having said outer wall of said canister engaging said outside wall of said sleeve and having said basal wall being spaced from said bottom wall to define a cooling space between said basal wall and said bottom wall, said distal edge of said canister being aligned with said distal edge of said sleeve, said outside wall having an outer surface, said outer surface having a depression extending inwardly therein, said depression coiling around said outer wall and extending upwardly between said bottom wall and said distal edge to define a plurality of hills on said outer wall wherein said hills are configured to enhance gripping said canister, said outer wall having a threaded portion, said threaded portion extending downwardly from said distal edge of said sleeve;
a lid being with removably coupled to said sleeve such that said lid closes said canister wherein said lid is configured to inhibit the beverage from escaping said canister, said lid having a top wall and perimeter wall extending downwardly therefrom, said perimeter wall being continuous such that said lid has a circular shape, of said top wall having an opening extending therethrough wherein said opening is configured to facilitate the beverage to pour outwardly therethrough thereby facilitating the beverage to be consumed, said perimeter wall having an inside surface, said inside surface threadably engaging said threaded portion on said outer wall of said sleeve to retain said lid on said sleeve;
a spout being movably coupled to said lid such that said spout is in fluid communication with an interior of said canister wherein said spout is configured to have the beverage drunk therethrough, said spout having a first end and a second end, each of said first end and said second end being open, said first end being pivotally coupled to said top wall of said lid having said spout being aligned with said opening in said lid, said spout being positioned in a first position having said spout extending upwardly from said lid and having said first end being in fluid communication with said opening wherein said spout is configured to pass the beverage therethrough, said spout being positioned in a second position having said spout lying flat on said lid having said first end being removed from fluid communication with said opening wherein said spout is configured to inhibit the beverage from passing therethrough; and
a cooling unit being coupled to said sleeve such that said cooling unit is in thermal communication with said canister, said cooling unit using the Peltier effect to create a heat flux between said cooling unit and said canister wherein said cooling unit is configured to cool the beverage in said canister without ice, said cooling unit comprising:
a Peltier cooler having a first surface and a second surface, said Peltier cooler being positioned in said cooling space, said first surface of said Peltier cooler abutting said bottom wall of said canister such that said first surface is in thermal communication with said bottom wall, said second surface being heated when said Peltier cooler is turned on such that said first surface is cooled using the Peltier effect,
a heat sink being coupled to said sleeve wherein said heat sink is configured to be in thermal communication with ambient air, said heat sink being in thermal communication with said second surface of said Peltier cooler wherein said heat sink is configured to exchange heat between said second surface of said Peltier cooler and the ambient air, and
a power supply being coupled to said sleeve, said power supply being electrically coupled said Peltier cooler, said power supply comprising:
a switch being coupled to said outside wall of said sleeve wherein said switch is configured to be manipulated said switch being electrically coupled to said Peltier cooler such that said switch turn said Peltier cooler on and off,
at least one battery being positioned between said Peltier cooler and said basal wall of said sleeve, said at least one battery being electrically coupled to said switch, and
a charge port being coupled to said outside wall of said sleeve, said charge port being electrically coupled to said at least one battery, said charge port being configured to be electrically coupled to a power source thereby facilitating said at least one battery to be charged.
